(19) United States
(12) Patent Application Publication
(10) Pub. No.: US 2025/0379337 A1
(43) Pub. Date: Dec. 11, 2025

(54) Modular HVDC Busbar Assembly for Electrical System

(71) Applicant: Caterpillar Inc., Peoria, IL (US)

(72) Inventors: Prajod Krishnan Kutty, Kerala (IN); Chethan Ramakrishnaiah, Bengaluru (IN); Gregory S. Hasler, Pekin, IL (US); Sampathkumar Nachimuthu, Bengaluru (IN); Firoz Ahamed, Bengaluru (IN)

(73) Assignee: Caterpillar Inc., Peoria, IL (US)

(21) Appl. No.: 18/740,076

(22) Filed: Jun. 11, 2024

(51) Int. Cl. H01M 50/507; H01M 50/209

(52) U.S. Cl. CPC H01M 50/507; H01M 50/209

(57) ABSTRACT

A busbar assembly for electrically interconnecting a plurality of power racks arranged in a rack row includes first and second conductive busbars extending horizontally with respect to the rack row. The first and second conductive busbars electrically connect with first and second pluggable connectors extending rearward from the rack row orthogonal to the busbars. To interconnect the conductive busbars and pluggable connectors, the busbar assembly includes first and second conductive links that are shaped to extend between the components. To brace the busbars in parallel, the busbar assembly includes a support insulator that traverses and clamps to the busbars.

### TECHNICAL FIELD

This patent disclosure relates generally to an energy storage system for capturing electrical power for subsequent use and, more particularly, to a conductive busbar assembly for electrically interconnecting individual power modules within the energy storage system.

### BACKGROUND

An energy storage system (“ESS”) is an installation for receiving and storing electrical power for subsequent distribution and use. In larger applications, the ESS can be incorporated as part of a microgrid system that operates as a standalone electrical generation and distribution system (“an energy island”), separated from the larger utility grids, to provide electrical power for local applications and loads. Another application for ESS systems is for energy storage from renewable energy sources such as wind and solar power during peak generation periods. In some embodiments, the microgrid may be selectively integrated with a broad utility grid in a hybrid configuration to increase the possible sources of electrical power.

The quantity of electrical power stored by the ESS varies greatly depending upon the associated applications, including variability with the demand or load and with the power generation or supply sources. To accommodate variability, the ESS's are highly modular and their electrical power capacity can be scaled up and down as required. In an embodiment, the ESS can included several individual power modules, for example, individual rechargeable batteries, that can be grouped and electrically interconnected together. To organize the plurality of power modules and facilitate electrical interaction between them, the ESS can include one or more power racks that provide the structural framework that physically accommodates the individual power modules. To meet the variable electrical power requirements, individual power modules can be added to or removed from the ESS, or exchanged with modules of different ratings and configurations.

To meet the desired electrical ratings for the intended application, including the desired voltage and current, the individual power modules within the power racks may be interconnected in series and/or parallel circuits. Moreover, to enable swabbing individual power modules into and from the ESS, the ESS may include an arrangement of electrical conductors and electrical connectors interlinking the components. The present disclosure is directed to such an assembly and configuration for transmitting and regulating electrical power within an ESS.

### SUMMARY

The disclosure describes, in one aspect, an energy storage system including a rack row with a plurality of power racks adjacently arranged in a side-by-side configuration. The power racks can each include one or more power modules arranged in a vertical stack. To electrically connect the power modules and power racks, the energy storage system includes a busbar assembly having a first busbar and a second busbar extending in a horizontal direction with respect to the rack row. Protruding rearward from the rack row can be a first pluggable connector and a second pluggable connector each connected to a respective terminal projecting rearward from one of the plurality of power racks. A first conductive link and a second conductive link physically and electrically connect the first and second conductive busbars respectively to the first and second pluggable connectors.

In another aspect, the disclosure describes a method of electrically interconnecting a plurality of power racks adjacently arranged in a side-by-side configuration. A power module or power combiner that includes rearward projecting terminals can be plugged into first and second pluggable connectors aligned in the depth direction of one of the power racks. The first pluggable connector can be electrically connected with a first conductive link to a first conductive busbar extending in a horizontal direction orthogonal to the depth direction. Likewise, the second pluggable connector can be electrically connected by a second conductive link to a second busbar extending in the horizontal direction orthogonal to the depth direction.

In a further aspect, the disclosure describes a busbar assembly including a first conductive busbar and a second conductive busbar each configured as structural flat bars that are elongated and extend in parallel with each other. The busbar assembly also includes a first pluggable connector and a second pluggable connector each having a bifurcated connector clip orientated orthogonal to the first and second conductive busbars. To connect the pluggable connectors and the conductive busbars, the busbar assembly includes a first conductive link and a second conductive link each having a flat blade tongue receivable in the bifurcated connector clip and a flat abutment lug respectively connectable to the first and second conductive busbars.

### BRIEF DESCRIPTION OF THE DRAWINGS

FIG. 1 is a front perspective view inside of an energy storage system (ESS) with plurality of power racks adjacently arranged in a rack row and electrical interconnected by a busbar assembly extending horizontally proximate the rear rack faces and the rack roofs of the power racks.

FIG. 2 is a rear perspective view of the energy storage system (ESS) showing the busbar assembly extending horizontally proximate to the rear rack face and rack roofs.

FIG. 3 is a detailed perspective view of the busbar assembly including first and second conductive busbars electrically connected to first and second pluggable connectors protruding from the rear rack face.

FIG. 4 is a perspective view of the components of the busbar assembly detached from the energy storage system (ESS) and operatively arranged to firmly support the first and second conductive busbars with respect to the ESS.

FIG. 5 is a perspective view of an embodiment of the pluggable connector having a pluggable socket and a bifurcated connector clip that can be mounted to the rear rack face of the power racks.

FIG. 6 is a perspective view of an embodiment of the busbar assembly showing the conductive busbars secured in a horizontal arrangement by the support insulator.

FIG. 7 is a perspective view of an embodiment of the busbar assembly showing the conductive busbars secured in a vertical arrangement by the support insulator.

FIG. 8 is a perspective view of the busbar assembly including a perforated protective cover embodied as a structural C-channel partially enclosing the first and second conductive busbars.

### DETAILED DESCRIPTION

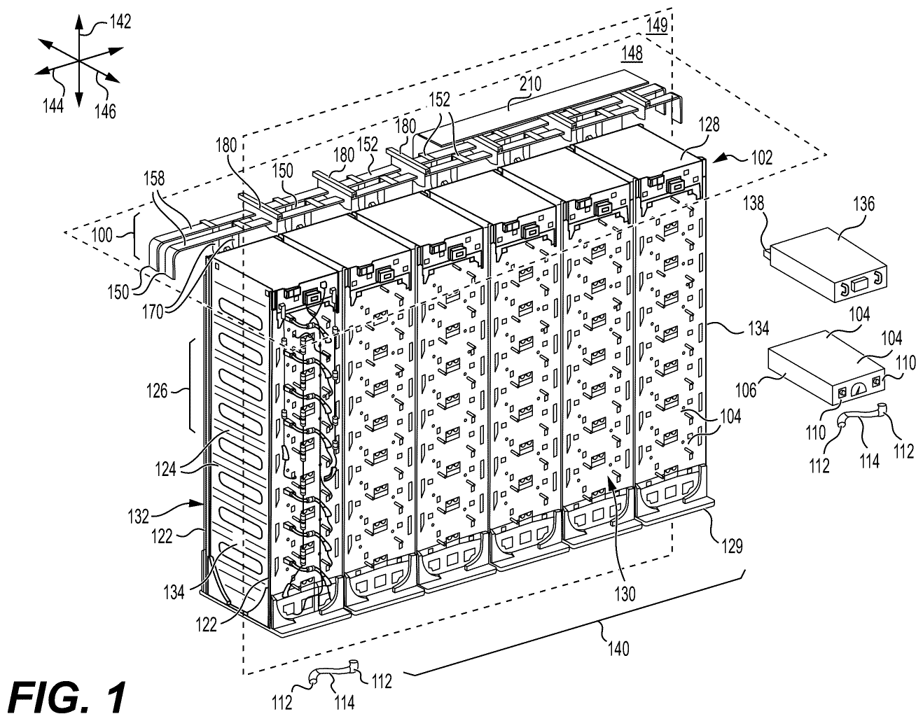

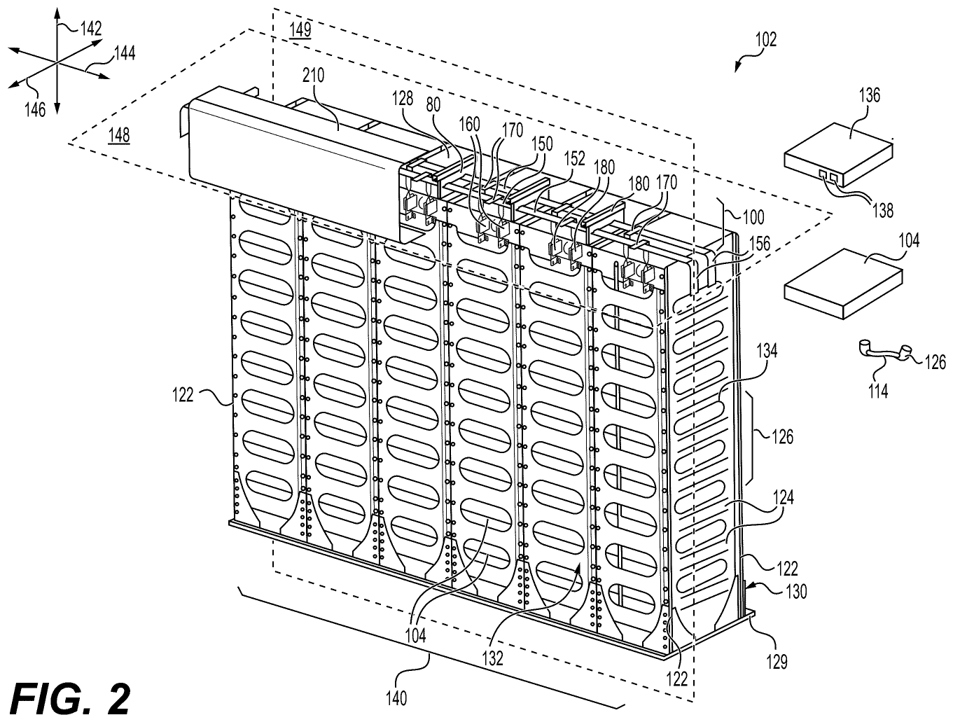

Now referring to the drawings, wherein whenever possible like reference numbers will refer to like elements, in FIGS. 1 and 2, there is illustrated a busbar assembly 100, also referred to as a busway assembly, operatively integrated with an energy storage system (“ESS”) 102 for the storage and redistribution of electrical power. The illustrated embodiment of the ESS 102 may be intended for high voltage, direct current (HVDC) applications, for example, with ratings approaching 1500V and in excess of 1000 kilowatts of power. However, aspects of the disclosure may be applicable to energy systems having different ratings and electrical characteristics.

The ESS 102 can be comprised of a plurality of individual power modules 104 that are cooperatively arranged together and electrically interconnected to combine their collective power output. The individual power modules 104 can be rechargeable batteries each assembled from a plurality of electrochemical cells that generate electricity from a chemical reaction. In rechargeable batteries, the electrochemical reaction is reversible so that the power module 104 can receive and store electrical power from a source for later distribution and use by a load. In other embodiments, the power module 104 may also be configured as a fuel cell that can also convert chemical energy to electrical power, and which can be periodically recharged by replenishment of the conversion fuel, such as hydrogen.

The individual power modules 104 can be physically configured as rack mountable, rectangular structures that are relatively squat and wide and the can be embodied by an exterior module shell 106 that contains the internal components such as the electrochemical cells and electrical connections. Each power module 104 can be designed to correspond to a rated capacity in terms of voltage, current, and power. In an embodiment, each power module 104 can also include a battery management system (“BMS”) 108 to monitor its operating characteristics during charging and discharging, for example, to prevent over charging and/or for circuit protection.

To transmit and receive the electrical power generated by or charged to the power module 104, one or more terminals 110 can be disposed on the exterior module shell and can make mating electrical connection with other modules and/or electrical equipment. For example, the terminals 110 can be configured as plug-in terminals on the front of the box-like exterior module shell 106, and more specifically are configured as sockets that are configured to mate with the male plug 112 of a flexible power cable 114 for conducting electrical power. As known in the art, the power cables 114 typically comprise an elongated conductive wire of, for example, copper covered in a protective sheath of an insulator material such as PVC or plastic. In addition to the terminals 110, the front of the module shell 106 can include various dials, switches, and controls for displaying and adjusting the operating conditions.

To physically accommodate a plurality of power modules 104 in an organized manner, the ESS 102 can include one or more racks 120, which provide the structural framework for supporting the individual power modules. For example, the racks 120 can have an upright columnar construction and the framework provided by the racks can be configured to accommodate a vertical stack of the power modules 104 to reduce the overall footprint associated with the plurality. In an embodiment, the power rack 120 can be configured to accommodate six to nine power modules 104 in a vertical arrangement, however, the number may differ in other embodiments. With the plurality of power modules 104 installed, the combination can be referred to as a power rack 120.

The power rack 120 can have an open frame construction exposing the plurality of power modules 104 therein to the environment for cooling, although in other embodiments, the power rack can include panels to construct an enclosed cabinet. The power rack 120 can include a plurality of vertical columns or upright posts 122 arranged in a square or rectangular pattern. Horizontal rails 124 can extend between the upright posts 122 to form vertically stacked shelves 126 at different elevations for the individual power modules 104. The vertical stack of rack shelves 126 can extend between and terminate at a rack roof 128 or ceiling and a vertically opposed rack floor 129, which may be configured as solid planar a structure or an open-framed structure.

The columnar construction resulting from the arrangement of the upright posts 122 and horizontal rails 124 interconnecting them provides the power rack 120 with an upright rectangular cuboid shape. For example, the power rack 120 can include front rack face 130 and an opposite, parallel rear rack face 132 that vertically extend between the rack roof 128 and the rack floor 129. The distance between parallel front and rear rack faces 130, 132 can correspond to the dimensional depth of the rack shelves 126 that extend between the faces. Furthermore, the power rack 120 can include first and second lateral side faces 134 that are parallel and opposite to each other and that are orthogonal to and extend between the front and rear rack faces 130, 132.

To allow insertion of the power modules 104 into the power rack, the front rack face 130 can have an opened frame construction providing access to the plurality of vertically arranged rack shelves 126. The rear rack face 132 may be fitted with a planar rear face panel 135 to partially enclose the interior envelope defined by the power rack 120. The planar rear face panel 135 can be fastened or joined to the upright posts 122 and can include apertures or openings to permit airflow into the rack shelfs 126 for cooling of the power modules 104 located therein.

In an embodiment, to transmit the combined power output of the plurality of power modules 104, the power rack 120 can also include a power combiner 136. The power combiner 136 can have a rectangular squat shape structurally similar to the rack-mountable power modules 104 and can occupy the vertically uppermost shelf 126 of the power rack 120. The power combiner 136 can be electrically connected with the plurality of power modules 104 in the power rack 120, for example, through a chain of the flexible power cables 114. The power combiner 136 can include internal circuitry and components to monitor and regulate the combined electrical output of the plurality of power modules 104 from the power rack 120.

To electrically connect with additional power racks 120, the power combiner 136 may include one or more rearward projecting terminals 138 that are oriented in the opposite direction of the forwardly directed terminals 110 of the power modules 104. When the power combiner 136 is installed in the uppermost shelf 126 of the power rack 120, the rearward projecting terminal 138 can be oriented toward the rear rack face 132. The rearward terminals 138 provide a common connection point to receive or deliver electrical power to the plurality of power modules 104 combined in the power rack 120. As per convention, the power combiner 136 can include first and second rearward terminals 138 associated with the positive and/or negative polarities.

To simplify connection, the rearward projecting terminals 138 can be configured as readily pluggable connections that can be quickly established or disconnected. In an embodiment, the rearward terminals 138 may each be a flat rigid blade of conductive metal extending from the body of the power combiner 136. The projecting flat blade can serves as a conductive contact to which a corresponding electrical connector can be attached. In other embodiment, the rearward terminals 138 can assume other quick and readily pluggable configurations.

To increase the power capacity of the ESS 102, multiple power racks 120 having the same height and depth can be arranged in an adjacent, side-by-side manner to form a rack row 140, also referred to as a battery bank. The inclusion of multiple power racks 120 into rack rows 140 increases the modularity and scalability of the ESS 102 to meet varying power demands. Scalability can be further increased by including multiple rack rows 140 in a single installation, for example, contained in a customized modular shipping container or other enclosed structure. The plurality of rack rows 140 can be separated by aisles for accessibility and airflow cooling.

The plurality of power racks 120 aligned in the rack row 140 may include bayed racks that are intermediately located between horizontally opposed end racks. The plurality of power modules 104 accommodated rack row 140 are oriented toward the forward rack faces 130 so that that an operator may access the forward terminals 110. The power combiners 136 are located in the rack row 140 so that the rearward terminals 138 are oriented toward the rearward rack faces 132.

For reference purposes, the three-dimensional shape of the rack row 140 or battery bank can establish a reference system or coordinate system. For example, the vertical direction 142 can be associated with the orientation of the upright posts 122 of the power racks 120 and the side-by-side alignment of the plurality of power racks 120 can be associated with a lateral or horizontal direction 144. As is characteristic of a Cartesian coordinate system, the vertical and horizontal directions 142, 144 are orthogonal to each other. In addition, the rack row 140 can include a depth dimension 146 that is perpendicular to the vertical direction 142 and extends traverse to the horizontal direction 144. The depth direction 146 can correspond to the dimension between the front rack face 130 and the rear rack face 132 and further corresponds with the dimensional depth of the power rack 120.

The physical arrangement of the rack row 140 can also establish one or more coordinate planes associated with the geometry of the ESS 102. For example, the horizontal direction 144 and the depth direction 146 can be disposed in and intersect within a horizontal plane 148. The horizontal plane 148 can be parallel to the rack roofs 128 and rack floors 129, and can be orthogonal to the vertical direction 142. In addition, the rack row 140 can be associated with a vertical plane 149, parallel with the upright poles 122 and extending vertically between the rack roofs 128 and rack floors 129. The vertical plane 149 can also be oriented parallel to the front rack face 130 and the rear rack face 132. The horizontal plane 148 and the vertical plane 149 are orthogonal to each other.

To transmit electrical power between the plurality of adjacently aligned power racks 120, the busbar assembly 100 is arranged to extend across the rack row 140 in the horizontal direction 144. The individual power modules 104 in the power racks 120 can electrically connect to the busbar assembly 100 as it extends proximate to each of the respective power racks 120. In the embodiments wherein the plurality of individual power modules 104 commonly connect with a power combiner 136 associated with each of the power racks 120, connection to the busbar assembly 100 can be made through the rearward projecting terminals 138 at the rear rack face 132 of the framework of the power rack 120. The busbar assembly 100 can therefore extend adjacent to the topmost shelves 126 of the power racks 120 proximately along the rack roofs 128 of the rack row 140.

The busbar assembly 100 is located externally of the rack row 140 and is spatially separated from the enclosure envelope defined by the plurality of vertical power racks 120. The busbar assembly 100 therefore does not interfere with or occupy space within the power racks 120 thereby increasing the energy density. The exteriorly situated busbar assembly 100 can located proximate the intersection of the rear rack faces 132 and the rack roofs 128, and can be vertically disposed over the rack roofs 128 for accessibility and visual observation. The exterior location of the busbar assembly 100 enables compact packaging of the plurality of power racks 120 into the rack rows and efficient use of space within the ESS 102.

The busbar assembly 100 can include a first conductive busbar 150 and a second conductive busbar 152, associated with the positive and negative polarities, that are flat, elongated strips of electrically conductive material such as copper that extend the horizontal length of the rack row 140. For example, the first and second conductive busbars 150, 152 can be arranged parallel to each other and oriented in the horizontal direction 144 of the rack row 140. The structurally flat metallic bars comprising the first and second conductive busbars 150, 152 can be produced by extrusion through a die and can have a flat cross section 154. The first and second conductive busbars 150, 152 can be substantially coextensive the horizontal direction 144 with the dimension in of the rack row 140, and the length of the first and second conductive busbars can be adjusted depending upon the number of power racks 120 included in the rack row 140.

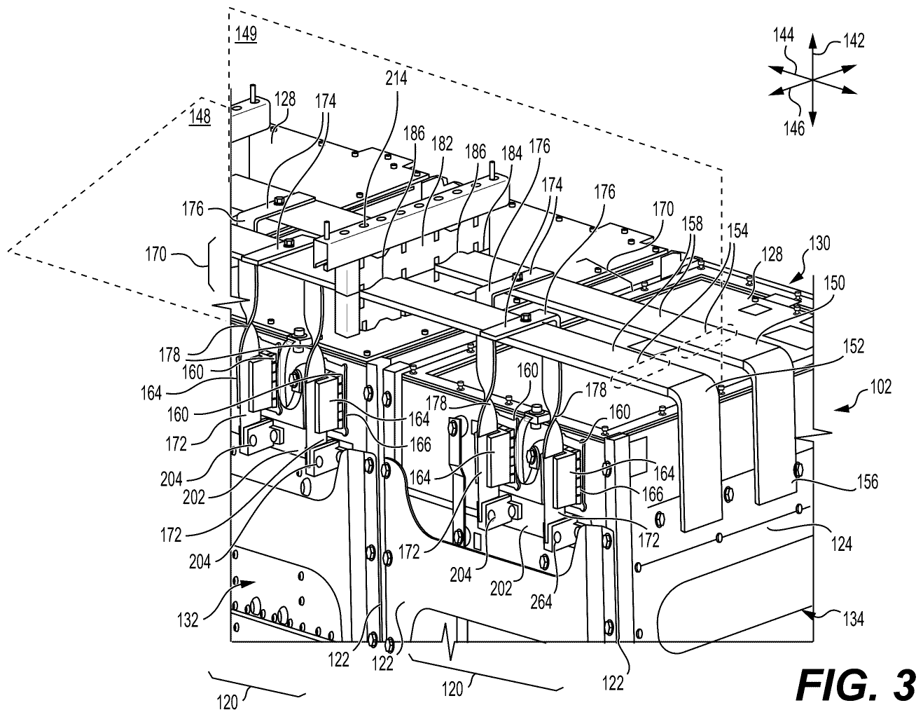

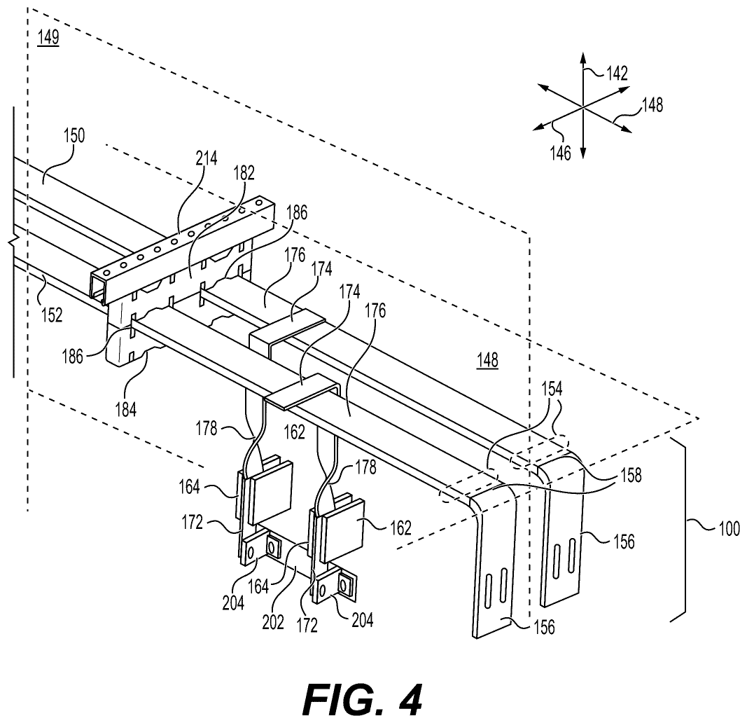

Referring to FIGS. 3 and 4, to enable the first and second conductive busbars 150, 152 to electrically connect with other devices, for example, with similar busbars, right-angled elbows 156 can be formed at the terminal ends of the busbars and that are aligned with the vertical direction 142. The right-angled elbows 156 can abut or attach to other conductive structures to form electrical connections and transmit power to and from the conductive busbars 150, 152. In an embodiment, to avoid unintentional contact and electrical shorting, the horizontal extensions of the conductive busbars 150, 152 can be coated in an insulation coating 158 such as molded PVC.

Referring to FIGS. 1 and 2, the first and second conductive busbars 150, 152 of the busbar assembly 100 are aligned and parallel with the horizontal direction 144 associated with the rack row 140. In addition, the first and second conductive busbars 150, 152 can be situated generally above and extend overhead of the rack roofs 128. In the illustrated embodiment, the flat cross sections 154 of the conductive busbars 150, 152 can be aligned parallel to the rack roofs 128 and thus parallel to the horizontal plane 148 of the rack row 140, although as described below, the conductive busbars may have a different geometric arrangement. The first and second conductive busbars 150, 152 are thus spatially and electrically separated from the rearward projecting terminals 138 at the rear rack face 132.

To electrically connect the spaced-apart rearward projecting terminals 138 and the first and second conductive busbars 150, 152, the busbars assembly 100 can include a plurality of uniquely arranged conductive connections and supports. For example, the rearward projecting terminals 138 can be electrically connected to and associated with respective first and second pluggable connectors 160. The pluggable connector 160 may be structurally identical. The pluggable connectors 160 can establish a connection alignment in the depth direction 146 and perpendicular to the horizontal direction 144. In an embodiment, the pluggable connectors 160 can be attached and secured to the planar rear face panel 135 at the rear rack face 132 projecting in the depth direction 146 to the exterior of the power rack 120.

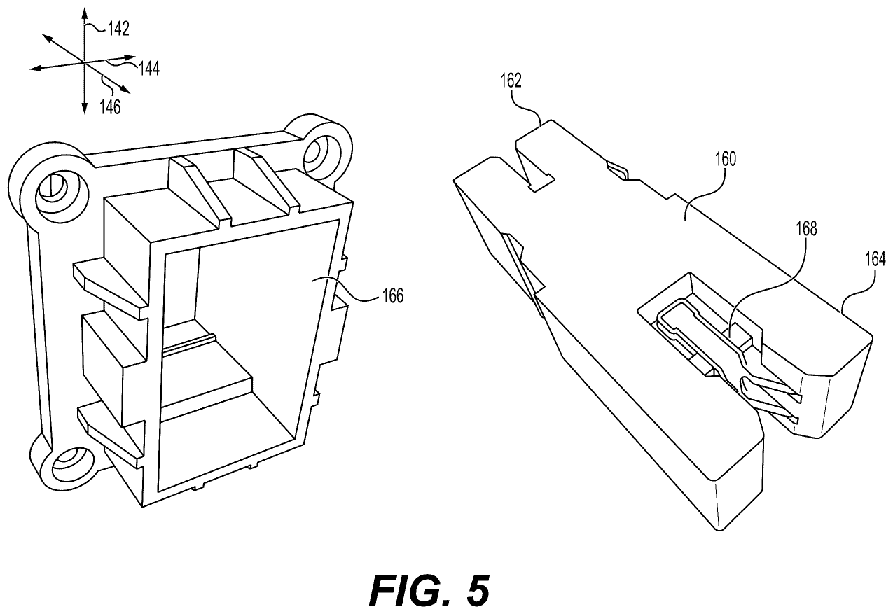

In an embodiment, the pluggable connectors 160 can be configured as quick connection fittings to establish or disconnect an electrical connection with the rearward projecting terminals 138 of the power combiner 136. For example, referring to FIG. 5, the pluggable connectors 160 can include a plugin socket 162 that configured to receive the rearward projecting terminals 138 when aligned and pressed together. The plugin socket 162 can include internally biased springs or the like to make sliding contact with and that can urge against the rear projecting terminals 138.

Accordingly, when the power combiner 136 is installed into the uppermost shelf of the power rack 120, electrical connection between the rearward projecting terminals 138 and the plugin socket 162 is established by pushing the components together. Further, the electrical connection between the plugin socket 162 and the rearward projecting terminals 138 can be established without fasteners and hardware, thus physical access to the interior spaces of the rack shelfs 126 during installation of the power modules 104 and power combiners 136 is unnecessary.

To form an electrical connection exteriorly of the power rack 120, the pluggable connectors 160 can include a bifurcated connector clip 164 located opposite the plugin socket 162130. The bifurcated connector clip 164 can configured as a two-pronged structure or fork that defines a connector slot there between. The fork of the bifurcated connector clip 164 and the connector slot there between are oriented and aligned with the plugin socket 162 so that the pluggable connector 160 defines a linear connection alignment.

The connector slot defined by the bifurcated connector clip 164 can receive an appropriately shaped tab that can be inserted therein. To make electrical contact with such a tab, the bifurcated connector clip 164 can include a plurality of U-shaped spring contacts 168 that are located within the connector slot and that correspond in shape with the fork. The legs of the U-shaped spring contacts 168 can be partially located within the connector slot and can be displaced and urge back against a tab inserted therein.

To securely mount the pluggable connectors 160 with the power racks 120, the pluggable connectors can be associated with a mounting frame 166. The mounting frame 166 can be a rectangular frame that can be attached proximate to a hole or passage disposed into the planar rear face panel 135, for example, with fasteners. The mounting frame 166 can define a slot through with the pluggable connectors 160 can be inserted and thus pass into the interior of the power rack 120. The mounting fame 166 can be made of an injection-molded polymer for electrical insulation. The molded body of the pluggable connector can include displaceable cantilevered springs that form a snap-fit connection with the mounting frame 166 where the components are inserted and pressed together.

Referring to FIGS. 3 and 4, to complete the electrical connection between the first and second conductive busbars 150, 152 extending in the horizontal direction 144 and the pluggable connectors 160 protruding from the rear rack face 132 in the depth direction 146, the busbar assembly 100 can include first and second conductive links 170. The conductive links 170 can be made of metal strips or bars that may be extended, bent, or displaced into an appropriate shape to physical interconnect the conductive busbars 150, 152 and pluggable connectors 160.

For example, the conductive links 170 can include, at opposite ends, a flat blade tongue 172 for insertion into the bifurcated connector clip 164 and a flat abutment lug 174 for attached to the conductive busbars 150, 152. When the flat blade tongue 172 is inserted into the bifurcated connector clip 164, the U-shaped spring contacts 168 therein can urge against the flat plane of the flat blade contact making electrical contact. Likewise, the flat abutment lug 174 can be placed adjacently against the flat surface of the conductive busbars 150, 152 and can be securely attached thereto by, for example, self-tapping fasteners.

To accommodate the difference in orientation between the pluggable connectors 160 in the depth direction 146 and the conductive busbars 150, 152 extending in the horizontal direction, the conductive links 170 can be configured as right angled fittings with the flat tongue blade 172 and the flat abutment leg 174 bent at a right angle bend 176 (90°) to each other. The flat blade tongue 172 can extend form the bifurcated connector clip 164 upwardly in the vertical direction 142, and the conductive link 170 can be reoriented by the right angle bend 176 so the flat abutment leg 174 extends over the conductive busbars 150, 152 extending in the horizontal direction 144. Furthermore, the flat blade tongue 172 can include a twisted portion 178 formed there along that re-orientates the flat extension approximately 90° within the vertical direction 142 and the vertical plane 149.

In the illustrated embodiment, the bifurcated connector clips 164 can extend coextensively in the depth direction 146 and the parallel first and second conductive busbars 150, 152 can be spaced apart with respect to the depth direction 146. To enable the conductive links 170 extending from the coextensive bifurcated connector clips 164 to interface with the respectively spaced apart conductive busbars 150, 152, the conductive links 170 can be arranged such that the flat abutment lugs 174 are oriented in opposing directions with respect to the depth direction 146.

To brace the first and second conductive busbars 150, 152 in the parallel and spaced apart arrangement, the busbar assembly 100 can include a plurality of support insulators 180. The plurality of support insulators 180 can be intermittently spaced lengthwise along the horizontal direction 144 in which the first and second conductive busbars 150, 152 extend and can be oriented in the depth direction 146 to traverse and bridge across the spaced apart conductive busbars.

To fixedly attach to the first and second conductive busbars 150, 152, the support insulators 180 can be configured as clamps and can include an upper brace 182 and a lower brace 184 that can be secured together to join the busbars there between. The upper and lower braces 182, 184 can be made from a polymer material and can be generally identical to each other. The upper and lower braces 182, 184 can be elongated, linear structures and can include complementary busbar passageways 186 structurally formed therein. When the upper and lower braces 182, 184 are joined together, the busbar passageways 186 combine to form a spatial gap within the support insulator 180 for the passage there through of the conductive busbars 150, 152.

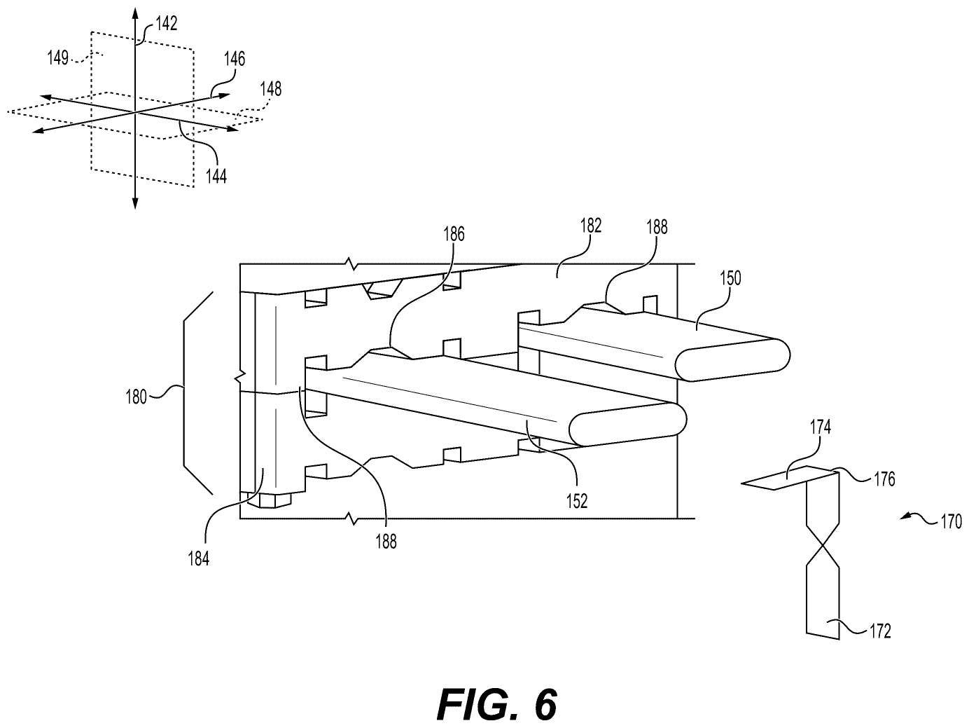

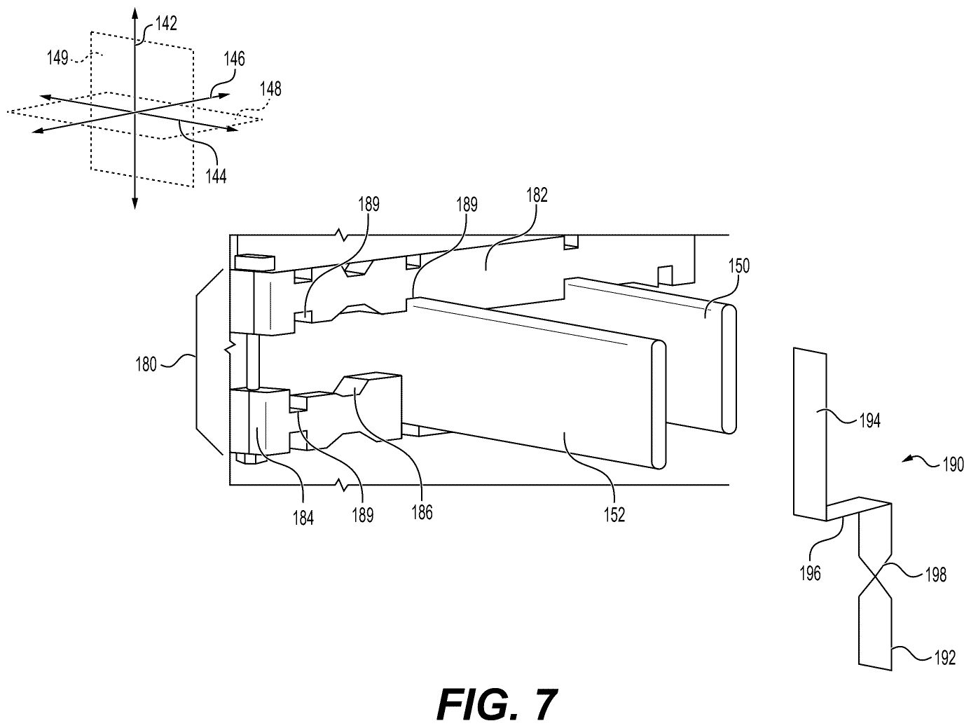

Referring to FIGS. 6 and 7, the support insulator 180 can be configured to enable different orientations and arrangement of the conductive busbars 150, 152 with respect to the rack row 140. For example, to accommodate the horizontal and vertical orientations of the first and second busbars 150, 152, the busbar passageways 186 can be generally shaped as an H including a horizontal slit 188 extending between two vertical slits 189. The horizontal slit 188 can be parallel with respect to the horizontal plane 148 of the rack row 140, in additional to extending in alignment with the depth direction 146, and the vertical slits 189 can be perpendicular to the horizontal plane 148 and aligned in the vertical direction 142.

In the embodiment of FIG. 6, with the conductive busbars 150, 152 extending horizontally over the rack roofs 128 parallel to the horizontal plane 148 of the rack row 140, the horizontal slit 188 of the busbar passages 186 fixes the flatten width of the conductive busbars 150, 152 parallel to the horizontal plane 148. The right angle bend 176 of the conductive links 170 orientates the flat abutment lugs 174 parallel with the horizontal plane 148 and adjacent to the flatten surfaces of the conductive busbars 150, 152.

If desired to orientate the first and second conductive busbars 150, 152 vertically, as in the embodiment of FIG. 7, the busbars can extend through the vertical slits 189 of the busbar passages 186. The vertical slits 189 of the busbar passages 186 thus fix the flat width of the first and second conductive busbars 150, 152 normal to the horizontal plane 148 and aligned with the vertical direction 142 parallel to the vertical plane 149. The design of the support insulators 180 can therefore accommodate the different arrangements of the busbar assembly 100.

To accommodate the vertical orientation of the first and second conductive busbars 150, 152, another embodiment of the conductive links 190 can be configured as a Z-links having double angled bend 196 as shown in FIG. 7. The double angled bend 196 locates the flat blade tongue 192 and the flat abutment lug 194 in a parallel but offset relation. Accordingly, the flat abutment lug 194 is oriented parallel to the vertical plane 149 and extends adjacently to the flattened surfaces of the conductive busbars 150, 152 and can be attached thereto by self-tapping fasteners. The conductive link 190 may also include a twisted portion 198 re-orientated the flat blade tongue 192 with respect to the horizontal and vertical planes 148, 149 to connect with bifurcated connector clip.

In an embodiment, referring to FIGS. 3 and 4, to secure the flat blade tongues 172 of the conductive links 170 to the bifurcated connector clips 166 of the pluggable connectors 160, the busbar assembly 100 can include a link bridge 200. The link bridge 200 can include a bridge strut 202 that can be an elongated strip and can be orientated in the horizontal direction 144 and normal to the depth direction 146. The elongated bridge strut 202 can extend adjacent to the planar rear face panel 135 of the power rack 120 between the spaced apart pluggable connections 160. The bridge strut 202 can be attached, for example, by threated fasteners to the planar rear face panel 135 at a location vertically below the pluggable connectors 160 projecting therefrom.

Projecting from the bridge strut 202 can be a pair of insulated link supports 204 that are aligned and extend in the depth direction 146. The insulated link supports 204 can be rectangular blocks of non-conductive, plastic material that protrude exteriorly from the planar rear face panel 135 of the power rack 120. The link supports 204 can be positioned vertically under the spaced apart pluggable connectors 160 and parallel to the projecting bifurcated connector clips 164. The link supports 204 can therefore abut and attach to the distal ends extending from the flat blade tongues 172 inserted into the connector slots of the bifurcated connector clips 164. The distal ends of the flat blade tongues 172 extending vertically below the bifurcated connector clips 164 can be secured to the link supports 204 by, for example, fasteners to secure the conductive links 170 proximate to the planar rear face panel 135 and prevent the flat bade tongues 172 from dislodging with respect to the pluggable connectors 160.

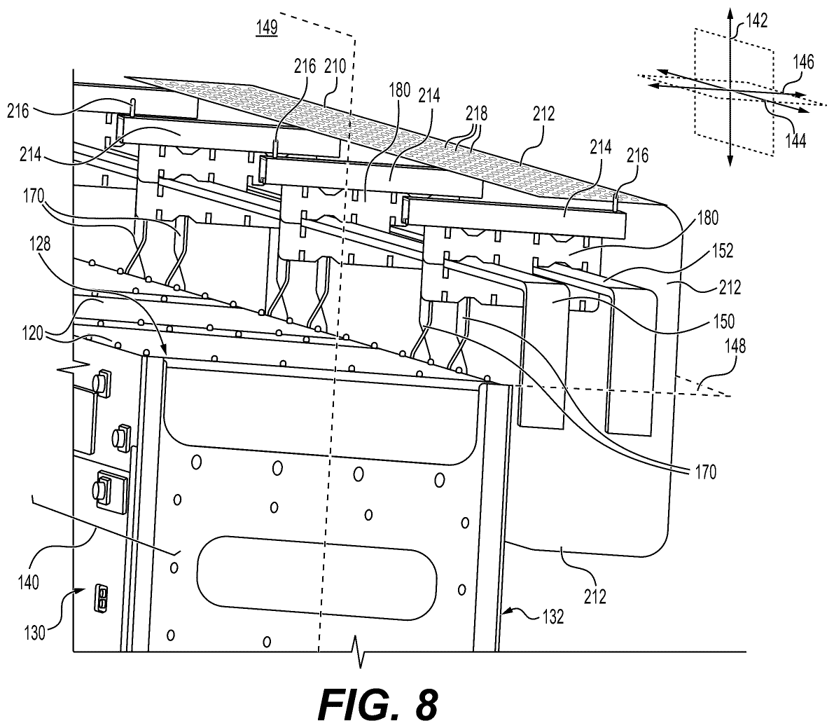

Referring to FIG. 8, to protect the busbar assembly 100 that is situated exteriorly of the rack row 140, a protective cover 210, configured as an elongated structural channel, can be disposed about horizontal length of the first and second conductive busbar 150, 152. For example, the protective cover 210 can be a three-sided C-channel having three orthogonally arranged walls, corresponding to a channel web and channel flanges 212 with the web extending orthogonally between parallel flanges. The orthogonally arranged channel web-and-flanges 212 are aligned in the horizontal direction 144 and can be generally arranged about the first and second conductive busbars 150, 152. The enclosed interior defined by the C-shaped cross section of the channel web-and-flanges 212 accommodates the elongated conductive busbars 150, 152 while the opened configuration simplifies assembly over the busbar assembly 100. The protective cover 210 can be generally coextensive with the first and second conductive busbars 150, 152 and can extend substantially the horizontal length of the rack row 140. The protective cover 210 can be made from an extruded, non-conductive material such as plastic.

To suspend the protective cover 210 about the conductive busbars 150, 152 located exteriorly of the rack row 140, the protective cover 210 can be connected to the plurality of support insulators 180 that brace the first and second conductive busbars 150, 152 and that are spaced along the horizontal direction 144. For example, a connection bar 214 can be mounted to the upper brace 182 that is oriented in the depth direction 146 perpendicular to the rear faces 132 of the plurality of power racks 120. The channel web-and-flanges 212 forming the protective cover 210 can be placed about the busbar assembly 100 so that one of the parallel opposed flanges rests adjacently over the connection bars 214 mounted to the support isolators 180 holing thereby supporting the protective cover 210 in a suspended, offset relation to the rack row 140. In an embodiment, the protective cover 210 and connection bars 214 can be attached by standoffs 216.

The enclosure provided by the three-sided channel web-and-flanges 212 of the protective cover 210 prevents inadvertent or accidental contact with the first and second conductive busbars 150, 152 that may be conducting significant amounts of electrical power. Moreover, the opened internal space defined by the three-sided channel web-and-flanges 212 of the protective cover 210 allows for airflow and convective cooling of the busbar assembly 100 contained therein. To further promote airflow while preventing accidental contact, one or more of the channel web-and-flanges 212 of the protective cover 210 can be perforated with a plurality of perforated apertures 218 that are sized to prevent unintentional access to the interior enclosure defined by the protective cover 210.

### INDUSTRIAL APPLICABILITY

Referring to the proceeding figures, the busbar assembly 100 enables the modular and scalable configuration of a plurality of vertical power racks 120 into a rack row 140 to selectively adjust the capacity of an energy storage system 102. The power combiner 136 can be installed by insertion into the uppermost rack shelf 126 so that the rearward projecting terminals 138 form a quick pluggable connection with the pluggable connectors 160 mounted to the planar rear face panel. The first and second conductive busbars 150, 152 of the busbar assembly 100 extending exteriorly of the rack row 140 in the horizontal direction 144 establishes electrical connection with the other power racks 120 included in the ESS 102. The number of adjacently aligned power racks 120 can be increased or decreased by adjusting the horizontal length of the first and second conductive busbars 150, 152 in response to power demand

The adjustable connectivity provided by the busbar assembly 100 thus enables the scalable energy storage system 102 to meet demand. In various embodiments, the busbar assembly 100 can be associated with an intelligent coupling system to enable selective disconnection of power racks 120. The energy storage system 102 can be readily adjusted to meet different voltage and power requirements of the loads associated with the field application. Moreover, fault power racks can be disconnected without causing complete failure of the energy storage system 102. The intelligent coupling system associated with the busbar assembly 100 may be managed remotely by an operator.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B”) is to be construed to mean one item selected from the listed items (A or B) or any combination of two or more of the listed items (A and B), unless otherwise indicated herein or clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. An energy storage system comprising:
a rack row including a plurality of power racks adjacently arranged in a side-by-side configuration, each of the plurality of power racks having one or more power modules in a vertically stacked arrangement;
a busbar assembly electrically interconnecting the one or more power modules in each of the plurality of power racks, the busbar assembly including:
a first conductive busbar and a second conductive busbar in a coplanar relation and extending in a horizontal direction with respect to the plurality of power racks in the rack row;
a first pluggable connector and a second pluggable connector each connected to a respective terminal projecting rearward from one of the plurality of power racks in a depth direction orthogonal to the horizontal direction; and
a first conductive link and a second conductive link physically and electrically connecting the first and second conductive busbars respectively to the first and second pluggable connectors.

2. The energy storage system of claim 1, wherein the first and second conductive busbars are configured as structural flat bars arranged parallel in the horizontal direction and spaced apart in the depth direction.

3. The energy storage system of claim 2, wherein the first and second conductive busbars are arranged horizontally and parallel to a horizontal plane, and the first and second conductive links each have a flat abutment lug connected to one of the first and second conductive busbars respectively and a right angle bend that locates the flat abutment lug parallel to the horizontal plane.

4. The energy storage system of claim 3, wherein the flat abutment lug of the first conductive link and of the second conductive link extend respectively oppositely to each other in the depth direction.

5. The energy storage system of claim 2, wherein the first and second conductive busbars are arranged vertically and parallel to a vertical plane, and the first and second conductive links each have a flat abutment lug connected to one of the first and second conductive busbars respectively and a double bend that locates the flat abutment lug parallel to the vertical plane.

6. The energy storage system of claim 2, wherein the busbar assembly includes a support insulator bracing the first and second conductive busbars together in parallel.

7. The energy storage system of claim 6, wherein the support insulator includes an upper brace and a lower brace aligned in the depth direction and arranged orthogonal to the horizontal direction to traverse and clamp the first and second conductive busbars.

8. The energy storage system of claim 7, wherein the support insulator includes a busbar passageway having a horizontal slit for accommodating the first and second conductive busbars when arranged horizontally and parallel to a horizontal plane in and a vertical slit for accommodating the first and second conductive busbars when arranged vertically and parallel to a vertical plane.

9. The energy storage system of claim 1, wherein the first and second pluggable connectors each include a bifurcated connector clip and the first and second conductive link each include a flat blade tongue that is receivable in the bifurcated connector clip.

10. The energy storage system of claim 9, wherein the busbar assembly further includes a link support that supportively attach the flat blade tongue of the first and second conductive link to the rack row.

11. The energy storage system of claim 1, wherein the busbar assembly further includes a protective covering of non-conductive material configured as a C-channel extending about the first and second conductive busbars.

12. A method of electrically interconnecting a plurality of power racks adjacently arranged in a side-by-side configuration, the method comprising:
plugging a power module into a first pluggable connector and a second pluggable connector projecting in a depth direction from one of the power racks;
electrically connecting the first pluggable connector to a first conductive busbar extending in a horizontal direction orthogonal to the depth direction with a first conductive link; and
electrically connecting the second pluggable connector to a second conductive busbar extending in the horizontal direction orthogonal to the depth direction with a second conductive link.

13. The method of claim 12, further comprising bracing the first and second conductive busbars in parallel co-planar arrangement in the horizontal direction with a support insulator.

14. The method of claim 13, wherein the support insulator includes a busbar passageway having a horizontal slit for accommodating the first and second conductive busbar when arranged horizontally and parallel to a horizontal plane in and a vertical slit for accommodating the first and second conductive busbars when arranged vertically and parallel to a vertical plane.

15. The method of claim 12, further comprising covering the first and second conductive busbars with a protective covering configured as a C-channel extending in the horizontal direction.

16. A busbar assembly comprising:
a first conductive busbar and a second conductive busbar each configured as structural flat bars elongated and extending parallel and co-planar to each other;
a first pluggable connector and a second pluggable connector each including a bifurcated connector clip orientated orthogonal to and spaced apart from the first and second conductive busbars; and
a first conductive link and a second conductive link each including a flat blade tongue receivable in the bifurcated connector clip and a flat abutment lug respectively connectable to the first and second conductive busbars.

17. The busbar assembly of claim 16, wherein first and second conductive busbars are arranged parallel and co-planar in a horizontal plane, and the first and second conductive links each have a right angle bend that locates the flat abutment lug parallel in the horizontal plane.

18. The busbar assembly of claim 16, wherein the first and second conductive busbars are arranged parallel to a vertical plane, and the first and second conductive links each have a double angle bend that locate the flat about lug parallel to the vertical plane.

19. The busbar assembly of claim 16, further comprising a support insulator bracing the first and second conductive busbars together in parallel.

20. The busbar assembly of claim 19, wherein the support insulator includes a busbar passageway having a horizontal slit for accommodating the first and second conductive busbars when arranged parallel to a horizontal plane in and a vertical slit for accommodating the first and second conductive busbars when arranged parallel to a vertical plane.
